(19) United States
(12) Patent Application Publication
(10) Pub. No.: US 2010/0023969 A1
(43) Pub. Date: Jan. 28, 2010

(54) DIGITAL PHOTO FRAME CAPABLE OF AUTOMATICALLY ENTERING AND SWITCHING OPERATIONAL MODES AND METHOD THEREOF

(75) Inventors: ZAI-AN PAN, Shenzhen City (CN); YUN XIAO, Shenzhen City (CN); LI-HUA HU, Shenzhen City (CN); CHIA-YU CHENG, Tu-Cheng (TW); KUAN-HONG HSIEH, Tu-Cheng (TW); HAN-CHE WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/269,043

(22) Filed: Nov. 12, 2008

(30) Foreign Application Priority Data
Jul. 25, 2008 (CN) 200810303075.1

(51) Int. Cl. H04N 5/445; H04N 5/66

(52) U.S. Cl. 725/39; 348/569; 348/E05.133

(57) ABSTRACT

A method used in a digital photo frame (DPF) for automatically entering and switching operational mode is provided. In an exemplary embodiment, the method includes: obtaining TV program information from a TV program table under a DPF mode; determining whether a TV program is on or about to start at the current time; automatically entering a TV mode or switching from the DPF mode to the TV mode when a TV program is on or about to start; and automatically receiving and playing the TV program.

### FIELD OF THE INVENTION

The present invention relates to a digital photo frame (DPF) capable of automatically entering and switching operational modes and method thereof.

### DESCRIPTION OF RELATED ART

Along with the rapid development in electronic technology, DPFs have become familiar to consumers. Some types of DPFs have been designed to not only play photos, but also broadcast television (TV) programs.

People get their favorite TV program schedule information mainly from entertainment sections in newspapers or from electronic program guides (EPGs). However, people may forget the broadcast times of their favorite TV programs and miss the favorite TV programs when they are busy with other things and have not been reminded of the upcoming TV programs. At present, some types of DPFs are capable of broadcasting TV programs. However, those types of DPFs cannot prompt users to watch their favorite programs on time by automatically entering a TV mode and broadcasting a favorite TV program of the users when the favorite program is on or about to start.

### SUMMARY

A digital photo frame (DPF) capable of automatically entering and switching operational modes is provided. The operational modes include a DPF mode for playing multimedia files and a television (TV) mode for playing TV programs. The DPF includes a processor, a TV receiving module, a storage and a clock module. The TV receiving module is configured for receiving TV programs. The storage is configured for storing at least a TV program table recording information on one or more TV programs. The information includes program names, broadcast times and TV station signs of the TV programs. The clock module is configured for providing current time. The processor includes a TV program information obtaining module, a clock information obtaining module, a comparison module, a mode switching module, a channel controlling module. The TV program information obtaining module is configured for obtaining the TV program information from the TV program table stored in the storage. The clock information obtaining module is configured for obtaining the current time from the clock module. The comparison module is configured for determining whether a TV program is on or about to start according to the TV program information and the current time. The mode switching module is configured for initializing the TV mode of the DPF if a TV program is on or about to start, thereby the DPF entering the TV mode after the DPF is powered on or switching from the DPF mode to the TV mode. The channel controlling module is configured for controlling the TV receiving module to receive the “currently on” or “about to start” TV program.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of a digital photo frame (DPF) capable of automatically entering and switching operational modes and method thereof. Moreover, in the drawings, like reference numerals designate corresponding parts throughout several views.

FIG. 1 is an isometric view of the DPF capable of automatically entering and switching operational modes in accordance with an exemplary embodiment of the present invention.

FIG. 2 is an block diagram of the DPF of FIG. 1 in accordance with an exemplary embodiment of the present invention.

FIG. 3 is a flowchart of the DPF of FIG. 1 automatically entering a TV mode after the DPF is powered on in accordance with an exemplary embodiment of the present invention.

FIG. 4 is a flow chart of the DPF of FIG. 1 automatically switching from a DPF mode to the TV mode in accordance with an exemplary embodiment of the present invention.

FIG. 5 is a flowchart of the DPF of FIG. 1 automatically switching from the TV mode to the DPF mode in accordance with an exemplary embodiment of the present invention.

FIG. 6 is schematic view for an exemplary embodiment of a switch apparatus of the DPF of FIG. 1.

### DETAILED DESCRIPTION OF THE EMBODIMENTS

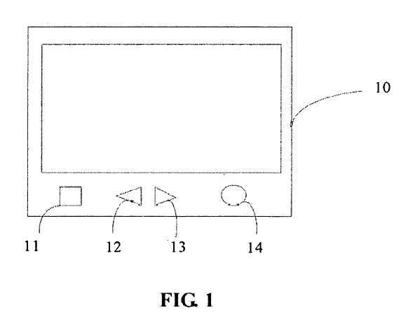

FIG. 1 is an isometric view of a digital photo frame (DPF) capable of automatically entering and switching operational modes in accordance with an exemplary embodiment of the present invention.

The DPF 10 mainly includes a power button 11, a play up button 12, a play down button 13 and a switch button 14. The power button 11 is configured for powering on and powering off the DPF 10. The play up button 12 and the play down button 13 are configured for users to select photos to play under a DPF mode of the DPF 10. The play up button 12 and the play down button 13 are also configured for the users to select TV channels under a TV mode of the DPF 10. The switch button 14 is configured for the users to manually switch operational modes between the DPF mode and the TV mode.

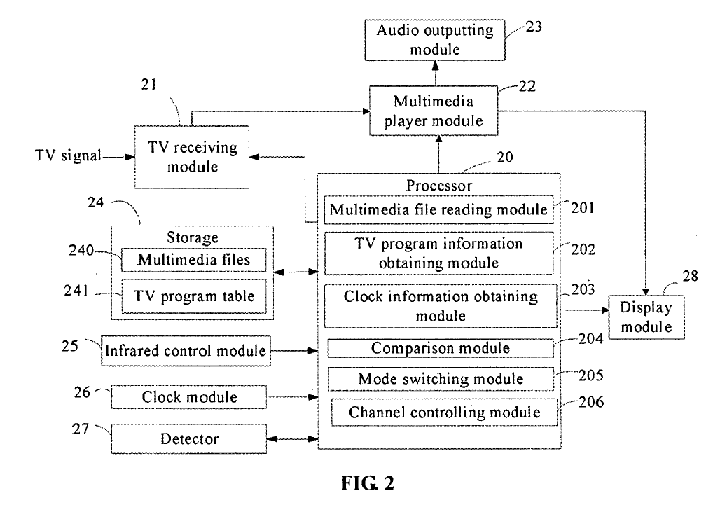

FIG. 2 is a block diagram of the DPF 10 in accordance with an exemplary embodiment of the present invention.

The DPF 10 includes a processor 20 connected to a TV receiving module 21, a multimedia player module 22, a storage 24 and a display module 28, which are controllable by the processor 20.

The storage 24 is configured for storing multimedia files 240 which may include photos, audio files, video files, and so on. The processor 20 obtains the multimedia files 240 from the storage 24 under the DPF mode, transmits the multimedia files 240 to the multimedia player module 22, such that the multimedia files 240 are played by the multimedia player module 22. The TV receiving module 21 is controlled by the processor 20 to receive TV programs under the TV mode, transmits the TV programs to the multimedia player module 22, such that the TV programs are played by the multimedia player module 22. The multimedia player module 22 is connected to both an audio outputting module 23 (e.g., a speaker) and the display module 28. The audio outputting module 23 is configured for outputting audio portion of the multimedia files 240 and the TV programs. The display module 28 is configured for outputting the image or video portion of the multimedia files 240 and the TV programs.

The storage 24 is further configured for storing at least a TV program table 241. The TV program table 241 can be inputted by the users or obtained from an electronic program guide (EPG) presented on the Internet. The TV program table 241 records information on one or more TV programs. The information includes program names, broadcast times and TV station signs of the TV programs. The broadcast times in one exemplary embodiment include starting times and ending times of the TV programs. The broadcast times in another exemplary embodiment include starting times and lengths of the TV programs. The TV station signs can be names or channel numbers of TV stations. If a TV station sign is the name of a TV station, the name is preset to correspond to a channel parameter of the TV station, the channel parameter enables the DPF 10 to receive TV programs from the TV station according to the name of the TV station recorded in the TV program table 241.

The DPF 10 also includes an infrared control module 25. The infrared control module 25 is configured for receiving infrared control signals from a remote control (not shown) and converts the infrared control signals to digital serial signals. The digital serial signals are sent to the processor 20 and the processor 20 adjusts various parameters of the controllable modules according to the digital serial signals. The play up button 12, the play down button 13 and the switch button 14 can also be integrated onto the remote control to control the play of the multimedia files 240 and TV programs.

The DPF 10 also includes a clock module 26 configured for providing current time information.

The DPF 10 also includes a detector 27 configured for detecting existence of the users in its detection zone. The detector 27 can be an infrared sensor or an ultrasonic sensor. The detector 27 is capable of detecting stay time of the users and acknowledging the users' existence only when the stay time reaches a preset minimum time length.

The processor 20 includes a multimedia file reading module 201, a TV program information obtaining module 202, a clock information obtaining module 203, a comparison module 204, a mode switching module 205 and a channel controlling module 206.

The multimedia file reading module 201 is configured for obtaining the multimedia files 240 from the storage 24. The TV program information obtaining module 202 is configured for obtaining the TV program information from the TV program table 241 stored in the storage 24. The clock information obtaining module 203 is configured for obtaining current time from the clock module 26. The comparison module 204 is configured for determining whether a TV program is on or about to start based on the TV program information and the current time. The mode switching module 205 is configured for switching operational modes between the DPF mode and the TV mode. The channel controlling module 206 is configured for controlling the TV receiving module 21 to receive TV programs of a particular TV channel. Generally, according to an exemplary embodiment, if the comparison module 204 determines a TV program is on or about to start, the comparison module 204 informs both the mode switching module 205 and the channel controlling module 206. The mode switching module 205 initializes the TV mode of the DPF 10, thereby the DPF 10 enters the TV mode after the DPF 10 is powered on or switches the DPF 10 from the DPF mode to the TV mode. The channel controlling module 206 controls the TV receiving module 21 to receive the TV program.

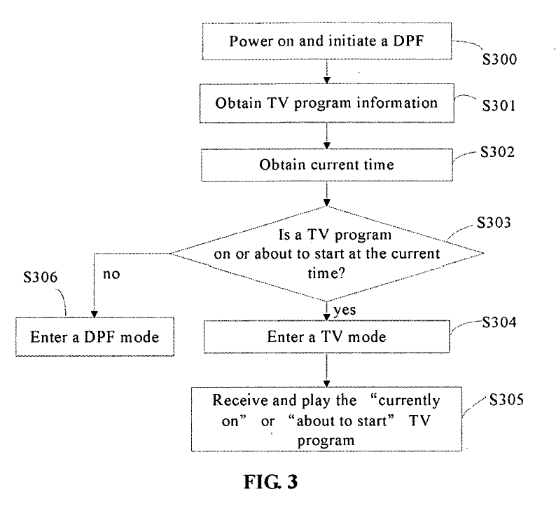

FIG. 3 is a flow chart of the DPF 10 automatically entering the TV mode sequentially after the DPF is powered on in accordance with an exemplary embodiment of the present invention.

In step S300, the power button 11 transmits signals to power on the DPF 10 and the DPF 10 executes an initialization process.

In step S301, the TV program information obtaining module 202 obtains the TV program information from the TV program table 241 stored in the storage 24.

In step S302, the clock information obtaining module 203 obtains the current time from the clock module 26.

In step S303, the comparison module 204 determines whether a TV program is on or about to start. If no TV program is on or about to start, the procedure goes to step S306 described below. If a TV program is on or about to start, the procedure goes to step S304 described below.

Generally, according to an exemplary embodiment, if the comparison module 204 determines that a TV program's starting time falls behind the current time in a first predetermined time interval, the TV program is classified as “about to start”. If the comparison module 204 determines that the current time is in the time frame of the TV program, the program is classified as “currently on”. In an alternative exemplary embodiment, if the comparison module 204 determines a TV program's starting time falls ahead of the current time in the first predetermined time interval, the TV program is classified as “currently on”. In yet another alternative exemplary embodiment, a second predetermined time interval is employed by the comparison module 204 to determine whether a TV program is currently on. If the TV program's starting time falls ahead of the current time in the second predetermined time interval, the TV program is classified as “currently on”. If a plurality of TV programs are on or about to start, the comparison module 204 selects one of the TV programs according to predefined rules and informs the channel controlling module 206 with the selected TV program, thereby the channel controlling module 206 controls the TV receiving module 21 to receive the selected TV program. In one embodiment, according to the rules, the selected TV program has a starting time nearest to the current time among all the “currently on” or “about to start” TV programs. In an alternative embodiment, according to the rules, the selected TV program has been placed on the top of the TV program table 241 among all the “currently on” or “about to start” TV programs. In another alternative embodiment, according to the rules, the selected TV program is a favorite of the users. If a plurality of favorite TV programs are currently on or about to start, the selected TV program has a starting time nearest to the current time or has been placed on the top of the TV program table 241 among all the “currently on” or “about to start” favorite TV programs.

In step 304, the mode switching module 205 initializes the TV mode of the DPF 10, thereby the DPF 10 enters the TV mode after the DPF 10 is powered on.

In step 305, the channel controlling module 206 controls the TV receiving module 21 to receive the selected TV program. The TV receiving module 21 transmits the TV program to the multimedia player module 22, thereby the DPF 10 plays the TV program.

In step 306, the mode switching module 205 initializes the DPF mode of the DPF 10, thereby the DPF 10 enters the DPF mode. Under the DPF mode, the multimedia file reading module 201 obtains the multimedia files 240 from the storage 24 and transmits the multimedia files 240 to the multimedia player module 22, thereby the multimedia files 240 are played by the DPF 10.

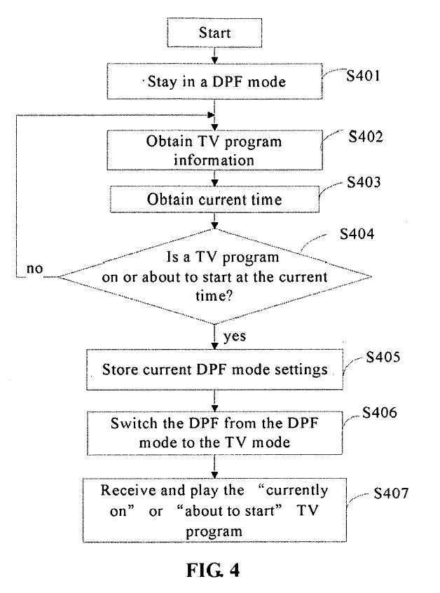

FIG. 4 is a flowchart of the DPF 10 automatically switching from the DPF mode to the TV mode in accordance with an exemplary embodiment of the present invention.

In step S401, the DPF 10 stays in the DPF mode and plays the multimedia files 240.

In step S402, the TV program information obtaining module 203 obtains the TV program information from the TV program table 241 stored in the storage 24 once every fixed time interval.

In step S403, the clock information obtaining module 202 obtains the current time from the clock module 27.

In step S404, the comparison module 204 determines whether one or more TV programs are on or about to start. If no TV program is on or about to start, the procedure goes to step S402 described above. If only one TV program is on or about to start, the procedure goes to step S405 described below. If a plurality of TV programs are on or about to start, the comparison module 204 selects one of the TV programs and informs the channel controlling module 206 with the selected TV program. The manners of determining whether one or more TV programs are on or about to start and selecting one from a plurality of “currently on” or “about to start” TV programs have been described above and the description will not be repeated here.

In step S405, the processor 20 automatically stores current settings under the DPF in the storage 24.

In another exemplary embodiment, the detector 27 detects whether a user exists in its detection zone and further detects whether the user's stay time reaches the preset minimum time length. If the user's stay time in the detection zone of the detector 27 reaches the preset minimum time length, the DPF 10 executes the step S406 described below. If the user does not exist for the preset minimum time length, the DPF 10 returns to execute step S402 described above.

In step S406, the mode switching module 205 initializes the TV mode and switches the DPF 10 from the DPF mode to the TV mode.

In step S407, the channel controlling module 206 controls the TV receiving module 21 to receive one of the “currently on” or “about to start” TV programs. The received TV program is transmitted to the multimedia player module 22 to play.

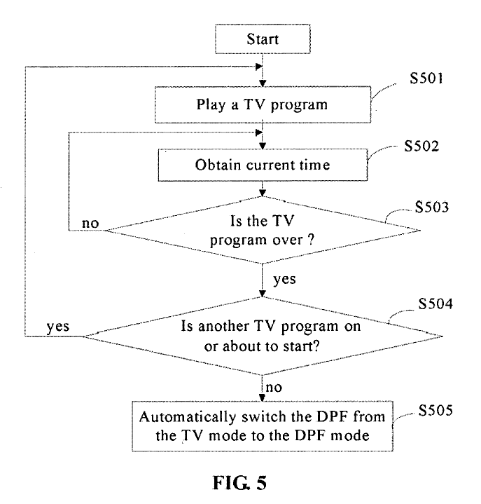

FIG. 5 is a flowchart of the DPF 10 automatically switching from the TV mode to the DPF mode in accordance with an exemplary embodiment of the present invention.

In step S501, under the TV mode, the DPF 10 plays a TV program which has been recorded in the TV program table 241.

In step S502, the clock information obtaining module 202 obtains the current time from the clock module 26 once every fixed time interval.

In step S503, the comparison module 204 determines whether the TV program is over. If the TV program is still on, the procedure goes to step S502 described above. If the TV program is over, the procedure goes to step S504 described below.

In step S504, the comparison module 204 determines whether one or more other TV programs recorded in the TV program table 241 are on or about to start. If only one TV program is on or about to start, the procedure goes to S501 described above. If a plurality of TV programs are on or about to start, the comparison module 204 selects one of the TV programs and informs the channel controlling module 206 with the selected TV program. The manner of determining whether one or more other TV programs are on or about to start and selecting one from the plurality of “currently on” or “about to start” TV programs have been described in relating to FIG. 3 and the description will not be repeated here. If no other TV program is on or about to start, the procedure goes to S505 described below

In step S505, the switching module 203 switches the DPF 10 from the TV mode to the DPF mode and the procedure is finished.

In an alternative embodiment, after switching to the DPF mode, the processor 20 will further obtain a DPF mode settings stored in the storage 24 and resume the DPF mode settings.

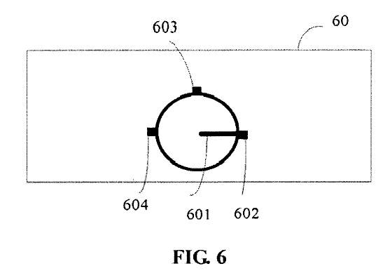

FIG. 6 is a schematic view for an exemplary embodiment of a switch apparatus.

The switch apparatus 60 can be set on the front or back of the DPF 10. The switch apparatus 60 is configured for fixing the DPF 10 in the DPF mode or in the TV mode, or setting the DPF 10 in an automatically switching mode which switches the DPF 10 between the DPF mode and the TV mode automatically. The switch apparatus 60 has a movable portion 601 which can be manually moved to and suspended at three positions: a first of the positions representing the DPF mode and hereinafter referring to as the DPF mode position 602; a second of the positions representing the automatically switching mode and hereinafter referring to as the automatically switching mode position 603; and a third of the positions representing the TV mode and hereinafter referring to as the TV mode position 604. When the movable portion 601 is suspended at the automatically switching mode position 603, the DPF 10 is capable of automatically switching between the DPF mode and the TV mode. When the movable portion 601 is suspended at the DPF mode position 602, the DPF 10 is fixed at the DPF mode. When the movable portion 61 is suspended at the TV mode position 604, the DPF 10 is fixed at the TV mode. When the DPF 10 is fixed at the DPF mode or the TV mode, the switch button 14 is incapable of switching operational modes between the DPF mode and the TV mode.

Although the present invention has been specifically described on the basis of preferred embodiments and method thereof, the invention is not to be construed as being limited thereto. Various changes or modifications may be made to the embodiments without departing from the scope and spirit of the invention.

What is claimed is:

1. A digital photo frame (DPF) capable of automatically entering and switching operational modes comprising a DPF mode and a television (TV) mode, comprising:
a TV receiving module configured for receiving TV programs;
a storage configured for storing at least a TV program table containing information on one or more TV programs, the information comprising program names, broadcast times and TV station signs of the TV programs;
a clock module configured for providing current time;
a processor comprising:
a TV program information obtaining module configured for obtaining the TV program information from the TV program table stored in the storage;
a clock information obtaining module configured for obtaining the current time from the clock module;
a comparison module configured for determining whether a TV program is on or about to start according to the TV program information and the current time;
a mode switching module configured for initializing the TV mode of the DPF if a TV program is on or about to start, thereby the DPF entering the TV mode after the DPF is powered on or switching from the DPF mode to the TV mode; and
a channel controlling module configured for controlling the TV receiving module to receive the “currently on” or “about to start” TV program.

2. The DPF as described in claim 1, wherein the comparison module is further configured for determining whether the TV program is over under the TV mode, and the mode switching module is further configured for switching the DPF from the TV mode back to the DPF mode when the TV program is over.

3. The DPF as described in claim 1, wherein the comparison module is further configured for determining whether the TV program is over under the TV mode, and is further configured for determining whether another TV program is on or about to start when the TV program is over, the channel controlling module is further configured for controlling the TV receiving module to receive the another “currently on” or “about to start” TV program if the another TV program is on or about to start, and the mode switching module is further configured for switching the DPF from the TV mode back to the DPF mode if no another TV program is on or about to start.

4. The DPF as described in claim 1, wherein the broadcast times comprise starting times and ending times of the TV programs.

5. The DPF as described in claim 1, wherein the broadcast times comprise starting times and lengths of the TV programs.

6. The DPF as described in claim 1, wherein the broadcast times comprise starting times of the TV programs, the storage is further configured for storing at least one predetermined time interval, the comparison module is further configured for determining whether a TV program is on or about to start according to the starting times of the TV programs and the predetermined time interval.

7. The DPF as described in claim 2, wherein the processor is further configured for automatically storing current settings under the DPF in the storage before the mode switching module initializing the TV mode and switching the DPF from the DPF mode to the TV mode, and obtaining and resuming the stored DPF mode settings when the mode switching module switches the DPF from the TV mode back to the DPF mode.

8. The DPF as described in claim 3, wherein the processor is further configured for automatically storing current settings under the DPF in the storage before the mode switching module initializing the TV mode and switching the DPF from the DPF mode to the TV mode, and obtaining and resuming the stored DPF mode settings when the mode switching module switches the DPF from the TV mode back to the DPF mode.

9. The DPF as described in claim 1, wherein the DPF further comprises a detector configured for detecting existence of a user in its detection zone when the comparison module determines a TV program is on or about to start, and the mode switching module is configured for initializing the TV mode and switching the DPF from the DPF mode to the TV mode only when the detector detects that the user exists for a preset minimum time length.

10. The DPF as described in claim 1, wherein the DPF further comprises a switch apparatus configured for selectively fixing the DPF in the DPF mode or in the TV mode, or setting the DPF in an automatically switching mode which switches the DPF between the DPF mode and the TV mode automatically.

11. A method for automatically entering and switching operational modes of a digital photo frame (DPF), the operational modes comprising a DPF mode and a television (TV) mode, the method comprising:
obtaining TV program information from a pre-stored TV program table, the information comprising program names, broadcast times and TV station signs of one or more TV programs;
obtaining current time;
determining whether a TV program is on or about to start according to the TV program information and the current time;
automatically initializing the TV mode of the DPF if a TV program is on or about to start, thereby the DPF entering the TV mode sequentially after the DPF is powered on or switching the DPF from the DPF mode to the TV mode; and
automatically receiving and playing the “currently on” or “about to start” TV program.

12. The method as described in claim 11, further comprising:
determining whether the TV program is over; and
automatically switching the DPF from the TV mode to the DPF mode when the received TV program is over.

13. The method as described in claim 11, further comprising;
determining whether the TV program is over;
determining whether another TV program is on or about to start when the TV program being played is over;
receiving and playing the another TV program when the another TV program is on or about to start; and
automatically switching the DPF from the TV mode to the DPF mode when no another TV program is on or about to start.

14. The method as described in claim 12, further comprising:
automatically storing current settings under the DPF mode before initializing the TV mode and switching the DPF from the DPF mode to the TV mode; and
automatically obtaining and resuming the stored DPF mode settings when switching the DPF from the TV mode back to the DPF mode.

15. The method as described in claim 13, further comprising:
automatically storing current settings under the DPF mode before initializing the TV mode and switching the DPF from the DPF mode to the TV mode; and
automatically obtaining and resuming the stored DPF mode settings when switching the DPF from the TV mode back to the DPF mode.

16. The method as described in claim 11, further comprising:
detecting whether a user exists before automatically initializing the TV mode; and
automatically initializing the TV mode only when the user exists.
